(19) United States
(12) Patent Application Publication
(10) Pub. No.: US 2023/0393406 A1
(43) Pub. Date: Dec. 7, 2023

(54) DIGITISING DRAWINGS

(71) Applicant: Hewlett-Packard Development Company, L.P., Spring, TX (US)

(72) Inventors: FRED CHARLES THOMAS, III, FORT COLLINS, CO (US); J. MICHAEL STAHL, FORT COLLINS, CO (US); DEREK LUKASIK, FORT COLLINS, CO (US); BRUCE ERIC BLAHO, FORT COLLINS, CO (US); CHRISTIAN MAMPREY DAMIR, FORT COLLILNS, CO (US)

(21) Appl. No.: 18/249,496

(22) PCT Filed: Oct. 30, 2020
(86) PCT No.: PCT/US2020/058369

§ 371 Date: Apr. 18, 2023

(51) Int. Cl. G02B 27/01

(52) U.S. Cl. CPC G02B 27/0176

(57) ABSTRACT

A method to determine a position of an inkable substrate located on a drawing area of an input device is disclosed. The method comprises detecting one or more physical features of the inkable substrate using a sensor that is positionally fixed relative to the drawing area of the input device, and determining, based on the detected physical features of the inkable substrate, a position of the inkable substrate with respect to the drawing area of the input device.

### BACKGROUND

Head mounted displays (HMD) have many useful applications. In recent years, HMDs have found application in engineering, aviation, research, medicine and recently, with the advent of virtual reality (VR) technology, gaming. In recent years the cost of VR headsets has fallen while the quality of VR technology has improved. This has led to more widespread adoption of HMD devices among consumers and in commercial settings.

### BRIEF DESCRIPTION OF THE DRAWINGS

FIG. 1 is a schematic diagram showing a head mounted display assembly, according to an example;

FIG. 2 is a schematic diagram of a head mounted display assembly and accessory device, according to an example;

FIG. 3 is a block diagram of a method for coupling an accessory to a head mounted display assembly, according to an example;

FIG. 4 is a schematic diagram showing a processor and memory, according to an example.

### DETAILED DESCRIPTION

In the following description, for purposes of explanation, numerous specific details of certain examples are set forth. Reference in the specification to “an example” or similar language means that a particular feature, structure, or characteristic described in connection with the example is included in at least that one example, but not necessarily in other examples.

A head-mounted display (HMD) is a display device, worn on the head of a user. In some cases, a HMD may form part of a helmet or other form of headgear. Virtual Reality (VR) devices are HMD devices that include inertial measurement units (IMU).

HMDs are widely deployed in fields such as aviation, medical science, various research fields and in consumer electronics such as VR.

An HMD device may comprise an assembly which includes a supporting frame that may be placed on the user's head. Some devices come with a strap to be placed around the user's head. HMD devices may have integrated displays. Some HMD devices allow a user to place a display device in the supporting frame.

HMD devices such as consumer VR devices comprise lenses and semi-transparent mirrors embedded in eyeglasses. Displays may be miniaturized and may include liquid-crystal displays (LCD), liquid crystal on silicon (LCos), or organic light-emitting diode (OLED) displays.

Many HMD devices display computer-generated imagery (CGI), live imagery from the physical world, or a combination of both CGI and live imagery. So-called augmented reality (AR) devices allow a CGI to be superimposed on a view of the real-world.

Collaboration in virtual environments through the use of VR technology has also found many applications in recent years. A collaborative virtual environment allows individuals to interact with each other remotely over geographically separated locations. In these settings, VR provides the individuals with an enhanced immersive experience improving opportunities to co-operate and collaborate with each other within the same virtual space.

Up until now, VR collaboration has mostly relied on the use of expressionless avatars which capture a minimal amount of biometric information from the user. There is growing interest in the use of new technologies to capture more expressive, interesting biometric information from users and other data in these settings. One example of such a camera is a “mouth cam”. This camera may be directed towards a user's lower face to capture mouth movements. Other examples include depth cameras to capture three dimensional perception, object-tracking cameras and sensors such as olfactory sensors.

One option is to provide an HMD assembly with an integrated accessory device. For example, a camera may be fixed to a portion of the frame of the HMD assembly. This is, however, undesirable from a user's point of view. For example, a user may use the accessory on an intermittent basis. In that case, when the accessory is not being used, it is surplus to the requirement of the user. Furthermore an integrated accessory device makes the HMD assembly more cumbersome and increases the overall weight, thereby reducing the performance of the HMD device.

The HMD assembly described herein alleviates the aforementioned disadvantages of an integrated accessory by providing a mounting interface for releasably coupling an accessory device to the assembly. That is, a user may attach an accessory device to the mounting interface and remove the accessory device when it is no longer in use. The releasable coupling is provided by a magnetic portion which attracts an opposing magnetic portion of an accessory device to the HMD assembly, when the accessory device is properly aligned with the mounting interface. Furthermore the magnetic portion of the mounting interface repels the accessory device if a user attempts to attach the accessory device in a manner where the opposing magnetic portion is misaligned.

The mounting interface may be used with a wide variety of accessory devices including the examples previously described. According to examples, the mounting interface is located on a lower surface of the HMD assembly. According to examples, the mounting interface is provided on the lower surface to give an accessory device attached to the mounting interface an unobstructed view of the lower portion of the user's view. In particular the mounting interface may be used to attach a “mouth cam” to the HMD assembly.

The mounting interface also provides a communication interface with the HMD assembly. For example, data may be communicated from the accessory device to the HMD assembly via the communication interface. In some examples, out-of-band communication may also be provided via one or more pins in the communication interface.

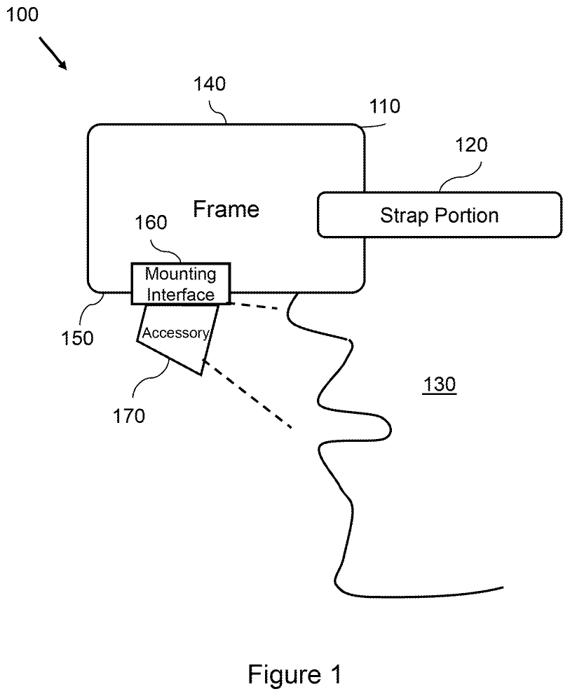

FIG. 1 is a simplified schematic diagram showing a head mounted display (HMD) assembly 100, according to an example. The HMD assembly 100 comprises a head supported structural frame 110. The head supported structural frame 110 may comprise a strap portion 120 arranged to fit around the head of a user 130 when the user is wearing the assembly 100. The strap portion 120 may be integral with the head supported structural frame 110. The strap portion 120 may also be detachable from the head supported structural frame 110. When the HMD assembly 100 is in use, the strap portion 120 ensures that the head supported structural frame 110 remains in place on the head of the user 130 and is not able to become dislodged from the users head if they move their head suddenly.

The head supported structural frame 110 is arranged to support a display (not shown in FIG. 1) that is viewable by the user 130 of the assembly 110. A display may be integral with the HMD assembly 110. For example, in some cases a display system may be provided comprising lenses and semi-transparent mirrors embedded into eyeglasses. The displays may be liquid-crystal displays (LCD), liquid crystal on silicon (LCos), or organic light-emitting diode (OLED) displays. In other examples, displays may be removable devices such as smartphones, which are inserted into the head supported structural frame 110.

The head supported structural frame 110 comprises an upper surface 140 and a lower surface 150. The lower surface 150 is the surface on the underside of the head supported structural frame 110, when the assembly 100 is worn on the head of the user 130 as shown in FIG. 1.

The assembly 100 further comprises a mounting interface 160 on the lower surface 150 of the structural frame 110. The mounting interface 160 is provided for releasably coupling an accessory device to the assembly 100. In FIG. 1, an accessory device 170 that is coupled to the mounting interface 160 is provided.

Herein, releasably coupling refers to the fact that the accessory device 170 may be coupled then uncoupled by the user 130. In some cases, an additional locking mechanism may be provided to secure the accessory device 170 to the assembly 100.

The mounting interface 160 comprises a magnetic portion (not shown in FIG. 1). The magnetic portion may comprise a north-south polarized magnetic element. The magnet portion is arranged to attract an opposing magnetic portion of the accessory device 170, when the accessory device 170 is aligned with the mounting interface 160. The magnetic portion is arranged to repel the opposing magnetic portion of the accessory device 170 upon misalignment with the mounting interface.

In other words, if a user attempts to attach the accessory device 170 in a configuration in which the accessory device 170 is correctly aligned with the mounting interface, the accessory device 170 will readily attach to the mounting interface 160, due to the magnetic attraction forces between the opposing magnetic portions of the mounting interface 160 and accessory device 170. On the other hand, if a user attempts to attach the accessory device 170 in a configuration which is misaligned with the mounting interface 160, the accessory device 170 is repelled from the mounting interface 160 due to the magnetic repulsion forces between the opposing magnetic portions of the mounting interface 160 and the accessory device 170.

The mounting interface 160 comprises a communication interface (not shown in FIG. 1) for communicating data with the accessory device 170. According to examples, the accessory device 170 may communicate data with the HMD assembly 100. For example, where the accessory device 170 is a camera, the visual data from the camera may be transmitted via the communication interface to the assembly 100.

In some cases, the communication interface may allow the accessory device 170 to transmit and receive data from another device separate from the assembly 100. For example, in the case where the display device is separate from the assembly 100, the communication interface of the mounting interface 160 may provide connectivity between the accessory device 170 and the display device.

In the example shown in FIG. 1, the mounting interface 160 is positioned on the lower surface 150 to provide the accessory device 170 with an unobstructed field of view of the user 130. This configuration allows a direct view of the users mouth and may be used to facilitate an improved interactive experience for the user. For example, in the case of the “mouth cam” this configuration and location of the mounting interface supports an improved experience for users in a VR collaboration environment where users can see each other's facial expressions.

According to an example, the mounting interface 160 is rotatable about an axis that is fixed relative to the assembly 100. In FIG. 1, such an axis may be the z-axis through the vertical of the assembly 100. Providing a rotatable mounting interface 160 allows the line of sight of the accessory 170 to be varied. This is may be used, for example, to provide visual data for the field of view in front of the user. In some cases, the mounting interface 160 may be rotated 180 degrees.

According to examples described herein, the communication interface of the mounting interface 160 comprises a set of pin connectors. The pins provide electrical contact between the accessory device 170 and the mounting interface 160. According to an example, the communication interface may be a universal serial bus (USB) interface. The pins may be pogo pins. Pogo pins allow the accessory device 170 to be electrically and communicatively connected and disconnected from the mounting interface efficiently. Pogo pins also provide improved durability and resilience of the mounting interface 160 to mechanical shock and vibration.

In some examples, one or more pins may also provide out-of-band signalling between the accessory device 170 and the assembly 100, or other device. For example, data received via out-of-band signalling may be used to determine battery life of the accessory device.

According to an example, the communication interface may be a wireless interface. For example, a near-field communication interface or an interface providing electromagnetically-coupled and/or power signals between the assembly 110 and the accessory device 170 may be provided.

In some cases, the mounting interface 160 may be contoured to match the shape and/or contour of the assembly 110. This ensures that the shape of the mounting interface 160 does not inconvenience a user when the accessory device 170 is not coupled to the mounting interface 160 and does not detrimentally affect the appearance of the assembly.

According to examples herein the accessory device 170 may comprise any one of the following devices: a mono infrared, mono visible or RGB camera, a depth camera, a filter-based depth camera, a stereo camera, a stereo camera with wide or adjustable spread, a forward-facing camera with integrated reflector, a hand or object tracking camera, a room mapping device, an olfactory device, a pulse detector, or a vapor detector and/or analyser. This is a non-exhaustive list of devices and does not limit the accessory devices that may be used in conjunction with the assembly device 100.

The examples described herein provide a head mounted display (HMD) assembly with a mounting interface. The mounting interface allows an accessory device to be attached to the assembly to provide an enhanced user experience. The accessory device may be decoupled and/or swapped out by the user with a different accessory device to provide a more versatile HMD assembly.

The assembly may be used in settings such as VR collaboration environments to give an improved collaborative experience for users in which user's expressions are captured by a camera attached to the mounting interface and communicated to other users.

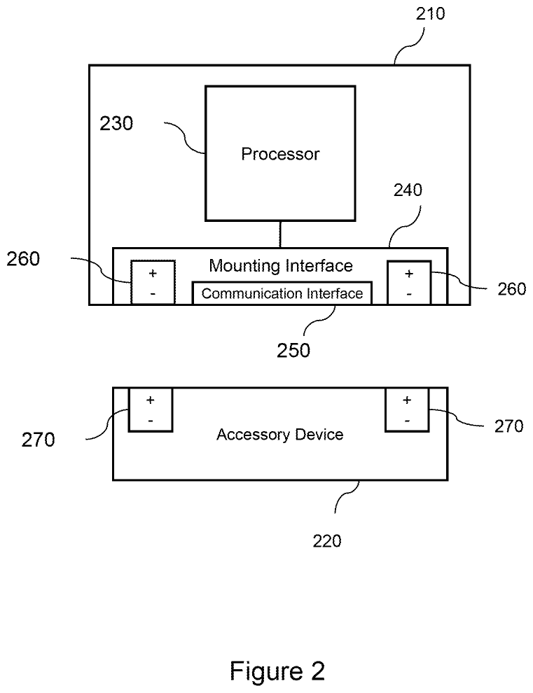

FIG. 2 shows a schematic diagram 200 of a head mounted display assembly 210 and accessory device 220, according to an example. The head mounted display assembly 210 comprises a processor 230 and a mounting interface 240, communicatively coupled to the processor 230. The mounting interface 240 comprises a communication interface 250 and magnetic portions 260. The accessory device 220 comprises opposing magnetic portions 270. The opposing magnetic portions 270 are attracted to the magnetic portions 260 of the head mounted display assembly 210, upon alignment of the accessory device 220 with the mounting interface 240.

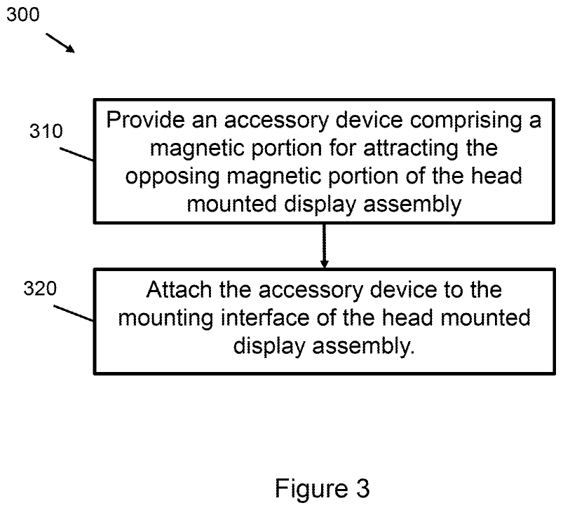

FIG. 3 shows a block diagram of a method 300 for coupling an accessory to the head mounted display assembly shown in FIG. 1. At block 310, the method 300 comprises providing an accessory device comprising a magnetic portion for attracting the opposing magnetic portion of the head mounted display assembly. At block 320, the method 300 comprises attaching the accessory device to the mounting interface of the head mounted display assembly.

According to examples, machine-readable instructions may, for example, be executed by a general-purpose computer, a special purpose computer, an embedded processor or processors of other programmable data processing devices to realize functions described in the description and diagrams. In particular, a processor or processing apparatus may execute the machine-readable instructions. Thus, modules of apparatus may be implemented by a processor executing machine-readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode.

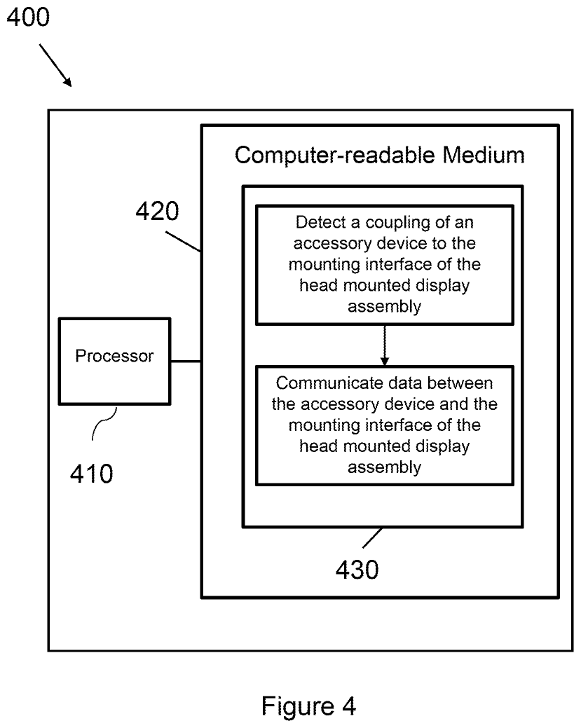

For example, the instructions may be provided on a non-transitory computer readable storage medium encoded with instructions, executable by a processor. FIG. 4 shows an example of a processor 410 associated with a memory 420 for use with the methods and systems described herein. The memory 420 comprises computer readable instructions 430 which are executable by the processor 410.

The instructions 430 cause the processor to: detect a coupling of an accessory device to the mounting interface of the head mounted display assembly and communicate data between the accessory device and the mounting interface of the head mounted display assembly.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer software product, the computer software product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the present disclosure. In particular, a feature or block from one example may be combined with or substituted by a feature/block of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A head mounted display assembly, comprising:
a head supported structural frame to support a display viewable by a user of the assembly, the structural frame including upper and lower surfaces;
a mounting interface on the lower surface of the structural frame, the mounting interface for releasably coupling an accessory device to the assembly, the mounting interface comprising:
a magnetic portion for attracting an opposing magnetic portion of the accessory device upon alignment of the accessory device with the mounting interface, and for repelling the magnetic portion of the accessory device upon misalignment of the accessory device with the mounting interface; and
a communication interface for communicating data with the accessory device.

2. The head mounted display assembly of claim 1, wherein the mounting interface is positioned on the lower surface to provide an accessory device coupled to the assembly with an unobstructed field of view of the user.

3. The head mounted display assembly of claim 1, wherein the mounting interface is rotatable about an axis that is fixed relative to the head mounted display assembly.

4. The head mounted display assembly of claim 1, wherein the communication interface comprises a set of pin connectors.

5. The head mounted display assembly of claim 4, wherein a subset of the pin connectors are pogo pin connectors.

6. The head mounted display assembly of claim 4, wherein a subset of the pin connectors provide out-of-band signalling between the assembly and an accessory device coupled to the assembly.

7. The head mounted display assembly of claim 1, wherein the communication interface is a universal serial bus (USB) interface.

8. The head mounted display assembly of claim 1, wherein the magnetic portion comprises a north-south polarized magnetic element.

9. The head mounted display assembly of claim 1, comprising a locking mechanism for securely locking an accessory device to the mounting interface.

10. The head mounted display assembly of claim 1, wherein the mounting interface is contoured to match a corresponding contour of the frame.

11. An accessory device for use with the head mounted display assembly of claim 1, the accessory device comprising a magnetic portion for releasably coupling the accessory device to the head mounted display assembly.

12. The accessory device of claim 11, wherein the accessory device is a mono infrared, mono visible or RGB camera, a depth camera, a filter-based depth camera, a stereo camera, a stereo camera with wide or adjustable spread, a forward-facing camera with integrated reflector, a cantilevered camera, a hand or object tracking camera, a room mapping device, an olfactory device, a pulse detector, or a vapor detector and/or analyser.

13. A non-transitory computer readable medium for the head mounted display assembly of claim 1, the non-transitory computer readable medium comprising instructions which are executable by a processor, to cause the processor to:
detect a coupling of an accessory device to the mounting interface of the head mounted display assembly; and
communicate data between the accessory device and the mounting interface of the head mounted display assembly.

14. A method for coupling an accessory to the head mounted display assembly according to claim 1, the method comprising:
providing an accessory device comprising a magnetic portion for attracting the opposing magnetic portion of the head mounted display assembly;
attaching the accessory device to the mounting interface of the head mounted display assembly.
